(19) United States
(12) Patent Application Publication
(10) Pub. No.: US 2024/0137346 A1
(43) Pub. Date: Apr. 25, 2024

(54) SYSTEM AND METHOD ENABLING NETWORKED SYSTEMS TO SAFELY USE DIGITAL CONTENT E.G. CODE

(71) Applicant: KAZUAR ADVANCED TECHNOLOGIES LTD., Tel-Aviv (IL)

(72) Inventors: Daniel Mondy FINCHELSTEIN, Rishon Lezion (IL); Yaacov FENSTER, Petach Tikvah (IL); Alexey SHEVANDIN, Tel Aviv (IL)

(21) Appl. No.: 18/264,170

(22) PCT Filed: Jan. 31, 2022
(86) PCT No.: PCT/IL2022/050134

§ 371 Date: Aug. 2, 2023

(30) Foreign Application Priority Data
Feb. 4, 2021 (IL) 280649

(51) Int. Cl. H04L 9/40

(52) U.S. Cl. CPC H04L 63/0428

(57) ABSTRACT

Method for distributing content to endpoint computers by sending signed content from a content-providing server to customer special-user workstations each including an enclave networked to its own subpopulation of endpoint computers which is a subset of the endpoint computers' population; and/or, in each enclave, authenticating that content received was signed by the server and then generating non-identical copies of the content received to be used by endpoint computers belonging to the individual enclave's subpopulation, signing the non-identical copies and sending the non-identical signed copies to endpoint computer/s in the enclave's subpopulation of endpoint computers, and/or in at least one enclave, authenticating that content received was signed by the given special-user workstation and then using the content received that was signed by the given special-user workstation, on or in the endpoint computer/s. Entity/ies may re-sign signed content verified by the individual entity using a combination of keys pre-provisioned in entities.

### BACKGROUND FOR THIS DISCLOSURE

Related co-owned technology is described in: PCT/IL2019/050343 published as WO 2019/186546, PCT/IL2019/050351 published as WO 2019/186554, PCT/IL2019/050332 published as WO 2019/186536, and PCT/IL2019/051238 published as WO 2020/105032.

Conventional technology constituting background to certain embodiments of the present invention is described in the following publications inter alia: Enclaves are known in the art. An enclave may reside in a minicomputer next to an endpoint computer, for example. Techniques supporting multiple secure enclaves are described in this co-owned patent document:
patents.google.com/patent/US20120159184A1/en.
   Examples of enclave hardware include but are not limited to:

Intel (SGX) which may have infrastructure e.g., as described here: software.intel.com/content/www/us/en/develop/topics/software-guard-extensions.html
AMD (EpEPYCyc SEV) e.g., as described in developer.amd.com/sev/
ARM (Platform Security Architecture);
IBM.

Frameworks for creating enclave software may include but are not limited to:
Intel SGX SDK
Analave Data vault
Fortanix Self-defending key management service (SDKMS),
Open Enclave Software Development Kit (SDK)
Confidential Consortium Framework (CCF)

Various uses of enclaves to enhance security are known. For example, according to this source:
dataspace.princeton.edu/bitstream/88435/dsp0112579w18r/1/Melara_princeton_0 181D_13161.pdf, Intel SGX enables developers to run sensitive code inside certain enclaves. Developers may include untrusted third-party libraries in such an enclave, giving those libraries unfettered access to all in-enclave data. So, Griffin (a memory access control system for Intel SGX cloud applications) uses Memory Protection Keys (MPK) to partition the enclave and assign per-compartment access rules. Developers can declare some data objects as sensitive and define access privileges for in-enclave functions, and Griffin then automatically confines such data objects in MPK compartments.

The disclosures of all publications and patent documents mentioned in the specification, and of the publications and patent documents cited therein directly or indirectly, are hereby incorporated by reference other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### FIELD OF THIS DISCLOSURE

The present invention relates generally to computer security and more particularly to security for computer networks.

### SUMMARY OF CERTAIN EMBODIMENTS

Certain embodiments seek to provide a secure method by which digital content, such as but not limited to an update package, can be distributed to plural destinations e.g., plural endpoints (e.g., workstations) some of which may themselves include plural subcomponents.

Certain embodiments seek to provide a secure method by which software code providers can send updates to their customers. Each customer typically comprises a computerized, typically networked organization e.g., company having plural endpoints and/or end-users.

Certain embodiments seek to provide a method for preventing interference with the supply chain of digital content.

Content e.g., software code may be signed and/or approved by all (or any subset of) the content provider aka provider, their customers, each customer's endpoints, and each endpoint's subcomponents. Thus, transport layers may include all or any subset of the following:

Central server/s to customer: typically, the central server (e.g., end-point producer; there may of course be plural such) distributes (e.g., as part of a periodic push of updates over a network) security software and/or hardware (which may include signing distribution of hardware) to customers (aka endpoint owners). Each customer typically includes a central special user workstation which may or may not use an enclave, and more typically is working in a secure area. The central special user workstation is responsible for plural endpoints, typically networked to the special user workstation (aka “special user”), each endpoint including its own enclave. The endpoint may include plural sub components, each having its own enclave. The special user may for example be an end-user in a customer's info-technology (IT) department, or administrator, who would be entitled to send s/w to other end-users in the customer's organization.

Customer to endpoint: typically, when the customer decides that the endpoint is to be updated, the customer tells the endpoint to download the package from an “update blob repository” inside the customer fortress.

Endpoint to sub-components: typically, depends on the target subcomponents. Secure input/output may be copied over an internal (to the endpoint) network. Re Unified Extensible Firmware Interface (UEFI) or BIOS, the package may be deposited on a pre-defined location on a shared persistent storage (boot partition) where the UEFI can access the package when the UEFI receives control up during the next boot of the endpoint.

Any suitable method or technology or communication channel may be employed to send content from a producer or provider to customers, e.g., over the network, or even via a physical media such as a DVD/CD.

Certain embodiments seek to provide a supply chain for digital content in which plural recipients e.g., endpoints, each have signing authority. Typically, a digital content supply chain with plural transport layers e.g., as described herein, is provided, in which no main or central authority or server knows all recipients' (e.g., all endpoints') keys. Typically, at least one entity or server at a given transport layer, does not have access to at least some keys used in the layers below the transport layer. For example, each server (e.g., customer, endpoint etc.) at each transport layer L, may have no access to any of the keys used by any of the servers in the layers below L.

Certain embodiments seek to provide a method whereby a component that contains an enclave receives content (e.g., an update) and re-signs that content (e.g. using an enclave), thereby serving as a trusted authority vouching for that content.

It is appreciated that presence of an enclave, running securely, advantageously allows re-signing or re-keying to be performed, according to embodiments herein e.g. as described herein in detail.

Typically, the system of the present invention includes logic configured to only use properly signed content. The logic or platform may include an enclave, which includes built-in mechanisms that validate that any code, executed by the platform, must have been properly signed. For example, see download.01.org/intel-sgx/linux2.1.3/docs/Intel_SGX_Developer_Reference_Linux_2.1.3_Open_Source.pdf for examples of signing code for execution in an Intel SGX secure enclave, and/or data in an enclave or in “normal” environments, conventional cryptographic schemes may be employed for validating the signature of the data using a private/public key pair.

Certain embodiments seek to provide a method whereby an enclave or trusted entity receives content e.g., an update and generates plural non-identical copies of that update (or content) to run on (or be otherwise used by) plural computers or endpoints respectively. The differences between the non-identical copies generated by the enclave may be in the actual content, e.g., “personalizing” (generating personalizations of) the content by adding personalization metadata, e.g., a logo and/or user name or any other personalized content that the customer (say) may add, which is typically unique to one or some computers, and not to any others. Alternatively or in addition, differences between the copies generated by the enclave may be in the signature with which the content is signed.

This yields a supply chain in which, when supplying content e.g., an update to, say, 50 organizations or customers each having 100 endpoints, the outcome may be 5000 unique and/or non-identical copies of the update, rather than 5000 identical copies of the update.

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

It is appreciated that any reference herein to, or recitation of, an operation being performed, e.g. if the operation is performed at least partly in software, is intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

The present invention typically includes at least the following embodiments:

Embodiment 1. A method for securely distributing content to a population of endpoint computers, wherein the method comprises at least 2 of the following 3 operations (which may also each operate standalone or independently):
Operation a. providing a hardware processor which may be configured to send signed content typically from at least one provider, aka content-providing server, to plural customer special-user workstations each including an enclave, wherein each special-user workstation, hence each enclave, may be configured to be networked to its own subpopulation of endpoint computers, wherein each said subpopulation may be a subset of the population of endpoint computers; and/or
Operation b. In each individual enclave from among said enclaves, providing a hardware processor which may be configured to authenticate that content received was signed by the at least one content-providing server and, having done so, to generate plural non-identical copies of said content received to run on or otherwise be used by plural endpoint computers belonging to the individual enclave's subpopulation of endpoint computers respectively, to sign said plural non-identical copies, thereby to yield plural non-identical signed copies, and to send said plural non-identical signed copies to at least some endpoint computers in the individual enclave's subpopulation of endpoint computers; and/or
Operation c. In at least one enclave within at least one endpoint computer, respectively, belonging to a given special-user workstation's subpopulation, providing a hardware processor configured to authenticate that content received was signed by the given special-user workstation and, having done so, to run or to otherwise use the content received that was signed by the given special-user workstation, on or in said at least one endpoint computer,

And wherein at least one individual entity from among the group of entities includes: the customers/trusted entities/special-user workstations, their endpoints, and their endpoint's subcomponents, if any, typically re-signs signed content which has been verified by said individual entity e.g. using a key which may be a combination of keys pre-provisioned in plural entities from among said group of entities.

It is appreciated that endpoints can, themselves, serve as customers, e.g. if the provider works directly vis a vis the endpoints without any separate customer entity intervening between the provider and the endpoints.

Or, customers can, themselves, serve as endpoints and may include a hardware processor configured to authenticate that content received was signed by the given special-user workstation, and, having done so, to, themselves, run or otherwise use the content received that was signed by the given special-user workstation.

It is appreciated that the special user may for example be an end-user in a customer's info-technology (IT) department, or administrator, who would be entitled to send s/w to other end-users in the customer's organization.

The method of Embodiment 1 may for example comprise operations a and b (in which case the method may operate in conjunction with another external system performing operation c), or may comprise operations a and c (in which case the method may operate in conjunction with another external system performing operation b), or may comprise operations b and c (in which case the method may operate in conjunction with another external system performing operation a), or may comprise operations a, b and c.

Embodiment 2. The method according to the preceding embodiment wherein the content comprises an update of software configured to run on at least some endpoint computers within the population of endpoint computers.

Embodiment 3. The method according to any of the preceding embodiments wherein the plural non-identical copies include personalization metadata.

Embodiment 4. The method according to any of the preceding embodiments wherein the plural non-identical copies are identical but for personalization metadata.

Embodiment 5. The method according to any of the preceding embodiments wherein the personalization metadata comprises a logo unique to or used by at least one individual enclave and not to or not by any enclaves other than the at least one individual enclave.

Embodiment 6. The method according to any of the preceding embodiments wherein the personalization metadata comprises a user name unique to or used by at least one individual endpoint computer belonging to an individual enclave's subpopulation, and not to or not by any endpoint computer belonging to the individual enclave's subpopulation other than the at least one individual endpoint computer.

Embodiment 7. A system comprising at least one hardware processor configured to carry out the operations of any of the methods shown and described herein.

Embodiment 8. The method according to any of the preceding embodiments wherein at least one endpoint computer's enclave re-signs at least one package of content using a key that is a combination of a key pre-provisioned inside the endpoint computer's enclave and of a key pre-provisioned inside the customer's enclave.

Embodiment 9. The method according to any of the preceding embodiments wherein plural subcomponents, each having enclaves, are managed by at least one endpoint, and at least one package/s of content intended for certain target subcomponent/s from among the plural subcomponents, is/are re-signed using a different key for each target sub component.

Embodiment 10. The method according to any of the preceding embodiments wherein at least one enclave on at least one endpoint computer, having authenticated that content received was signed by the given special-user workstation, uses the content locally.

Embodiment 11. The method according to any of the preceding embodiments wherein, having authenticated that that content received was signed by the at least one content-providing server, the individual enclave signs the content again (aka re-signs the content), thereby to yield re-signed content.

Embodiment 12. The method according to any of the preceding embodiments wherein the individual enclave re-signs the content received, thereby to yield the re-signed content, with a locally generated one-time key.

Embodiment 13. The method according to any of the preceding embodiments and wherein the re-signed content and, optionally, associated one time verification certificate, are stored in a local table whose location is known to at least one of the subcomponents, and subsequently, on at least one occasion on which at least one of the plural endpoint computers boots, the re-signed content and associated one time verification certificate are retrieved from the local table by at least one of the subcomponents.

Embodiment 14. The method according to any of the preceding embodiments and wherein the re-signed content, and, optionally, associated one time verification certificate, are sent directly to at least one of the subcomponents.

Embodiment 15. A computer program product, comprising a non-transitory tangible computer readable medium having computer readable program code embodied therein, the computer readable program code adapted to be executed to implement any operation shown and described herein.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes, or a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g., on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g., BLE) or wired (e.g., USB)), a computer program stored in memory/computer storage.

The term “process” as used above is intended to include any type of computation or manipulation or transformation of data represented as physical, e.g., electronic, phenomena which may occur or reside e.g., within registers and/or memories of at least one computer or processor. Use of nouns in singular form is not intended to be limiting; thus, the term processor is intended to include a plurality of processing units which may be distributed or remote, the term server is intended to include plural typically interconnected modules running on plural respective servers, and so forth.

The above devices may communicate via any conventional wired or wireless digital communication means, e.g., via a wired or cellular telephone network, or a computer network such as the Internet.

The apparatus of the present invention may include, according to certain embodiments of the invention, machine readable memory containing or otherwise storing a program of instructions which, when executed by the machine, implements all or any subset of the apparatus, methods, features and functionalities of the invention shown and described herein. Alternatively, or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g., digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g., chips, which may be co-located or remote from one another. Any controller or processor may, for example, comprise at least one CPU, DSP, FPGA or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure, or may be combined into fewer components. A statement that an element or feature may exist is intended to include (a) embodiments in which the element or feature exists; (b) embodiments in which the element or feature does not exist; and (c) embodiments in which the element or feature exist selectively e.g., a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage e.g., computer memory, may be used to store information received by or generated by the systems shown and described herein. Functionalities shown and described herein may be divided between server computer and/or a plurality of client computers. These or any other computerized components shown and described herein may communicate between themselves via a suitable computer network.

The system shown and described herein may include user interface/s e.g. as described herein, which may, for example, include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus, the term user interface, or “UI” as used herein, includes also the underlying logic which controls the data presented to the user e.g., by the system display and receives and processes and/or provides to other modules herein, data entered by a user e.g., using her or his workstation/device.

### BRIEF DESCRIPTION OF THE DRAWINGS

Example embodiments are illustrated in the various drawings. Specifically:

FIG. 1 is a simplified block diagram illustration of a system according to an embodiment of the present invention for securely distributing a package of data; the specifics of each customer and/or of each customer and/or or each endpoint may be as illustrated and/or may include a secure network operative in accordance with any embodiment shown or illustrated herewithin.

FIGS. 2a-2b, taken together, form a simplified flowchart illustration of a method for securely distributing a package of data; all or any subset of the operations therein may for example serve as a method of operation for all or any subset of the blocks in FIG. 1. It is appreciated that the terms package generator, Transport Package distributor, transport package receiver or customer, Certificate Authority, re-signer refer to software on a hardware processor which configures the hardware processor to perform the respective functionalities of each of these terms, as shown and described herein.

Each method typically comprises all or any subset of the illustrated operations, suitably ordered e.g., as shown.

Certain embodiments of the present invention are illustrated in the following drawings; in the block diagrams, arrows between modules may be implemented as APIs and any suitable technology may be used for interconnecting functional components or modules illustrated herein in a suitable sequence or order e.g., via a suitable API/Interface. For example, state of the art tools may be employed, such as but not limited to Apache Thrift or equivalents for serialization of data and/or function calls, and Avro or equivalents for define structures and APIS, which provide remote call support. Or, a standard communication protocol may be employed, such as but not limited to HTTP or MQTT, and may be combined with a standard data format, such as but not limited to JSON or XML.

Methods and systems included in the scope of the present invention may include any subset or all of the functional blocks shown in the specifically illustrated implementations by way of example, in any suitable order e.g., as shown. Flows may include all or any subset of the illustrated operations, suitably ordered e.g., as shown. Tables herein may include all or any subset of the fields and/or records and/or cells and/or rows and/or columns described.

Computational, functional or logical components described and illustrated herein can be implemented in various forms, for example, as hardware circuits, such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software (e.g., for execution on suitable processing hardware such as a microprocessor or digital signal processor), firmware, hardware (using any conventional hardware technology such as Integrated Circuit technology), or any combination thereof.

Functionality or operations stipulated as being software-implemented may alternatively be wholly or fully implemented by an equivalent hardware or firmware module, and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively, or in addition, modules or functionality described herein may be performed by a general-purpose computer, or more generally by a suitable microprocessor, configured in accordance with the methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option such as but not limited to FPGA, ASIC or DSP or any suitable combination thereof.

Any hardware component mentioned herein may in fact include either one or more hardware devices e.g., chips, which may be co-located or remote from one another.

Any method described herein is intended to include within the scope of the embodiments of the present invention also any software or computer program performing all or any subset of the method's operations, including a mobile application, platform or operating system e.g., as stored in a medium, as well as combining the computer program with a hardware device to perform all or any subset of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

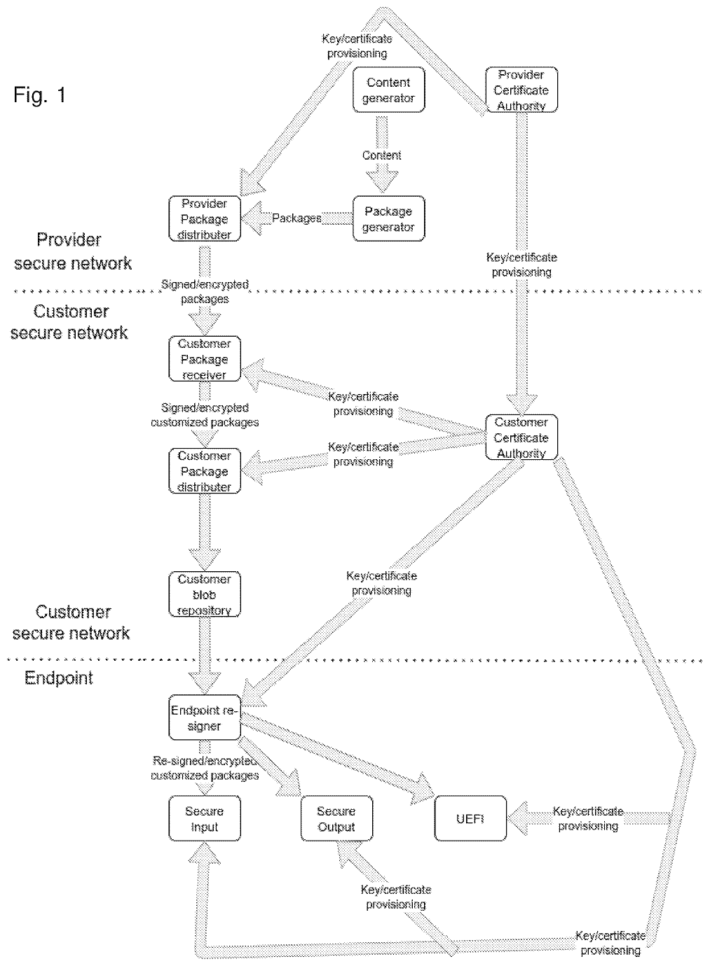

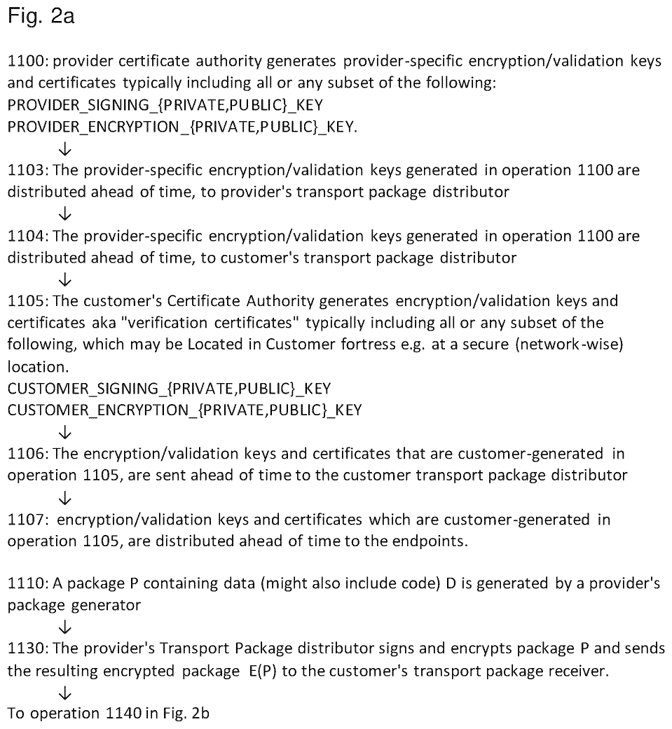

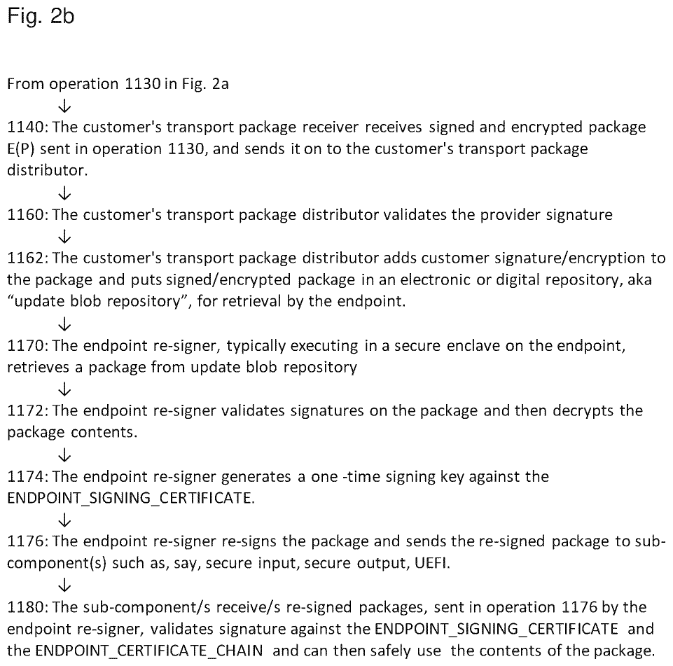

A system which distributes key management, and has re-packaging or re-signing functionality, is now described in detail with reference to FIG. 1.

According to certain embodiments, content is provided hierarchically, and in at least one level e.g. plural levels or even each level of the hierarchy, the content, typically after having been authenticated as having been received securely from a higher level e.g. provider, and typically after having been customized, e.g. uniquely for the entity which received the content from the higher level, is re-signed and re-encrypted by that entity, and then, typically, passed down a level to one or more entities in a lower level, with which the entity which received the content communicates securely (e.g. because the entity which received the content, and the lower level entities, store each others' keys).

It is appreciated that the customization may be non-substantive e.g. if the content is a code update, a logo associated with the code update may be customized, such that as the content travels down the hierarchy, the code update remains the same, but the logo associated therewith is unique to each recipient of the code update.

As shown, the system includes at least one provider, comprising a first secure network which typically generates packages or updates which are signed to attest to their authenticity e.g. as described herein, and/or at least one customer, comprising a second secure network, and/or at least one endpoint which may also comprise a secure network. However, the first and second secure networks may be one and the same, such that the provider and customer coincide, in certain embodiments, e.g. if a content (say software update) provider also provides security as a service, to its own customers.

Typically, the content (e.g. packages, updates etc.) generated and authenticated by the provider, are eventually installed securely in endpoints which the provider typically does not even know of, e.g. by using hierarchical distribution and repeated authentication and re-signing of the content at each level of the hierarchy, all of which may be as shown and provided herein.

The system's functional blocks, each of which may include at least one suitably configured hardware processor, are illustrated and are generally self-explanatory; note that all or any subset of the illustrated blocks may actually be provided in any given embodiment. The illustrated functionality, e.g. as described herein, allows the endpoints to know or authenticate exactly what content or update they are installing. Nonetheless, the system does not require the provider to hold the keys of each of the (possibly very numerous) endpoints in order to achieve this. Instead, keys can be distributed hierarchically by virtue of the re-signing flow as illustrated and/or as described hereinbelow. By virtue of the hierarchy, typically, each provider knows its customers (e.g. stores keys for secure communication therewith) and each customer knows its endpoints (e.g. stores keys for secure communication therewith), however, the provider does not store the keys of its own customers' customers (e.g. of the endpoints). While a hierarchy of 3 levels is illustrated by way of example, it is appreciated that n levels where n need not be 3 may more generally be provided. Typically, networks in adjacent levels store each others' keys, however typically, networks in non-adjacent levels do not store each others' keys. Thus a provider can securely deploy its content at a multiplicity of endpoints, without storing those endpoints' keys, e.g. due to the authentication and re-signing of content at each level which may proceed as described herein.

According to certain embodiments, at least one central server seeks to distribute content e.g., updates to endpoints (having enclaves) that are managed by the central server's customers (which also have enclaves). The endpoints are able to establish that the package came from the central server/s and/or the endpoints are able to establish that the package came from (a trusted or special user acting on behalf of) the customer. Typically, the central server/s signs content (e.g., an update package) and sends the signed content to a customer managed end point. An enclave on the endpoint, e.g. The mainboard/bases, verifies the signature. This endpoint enclave then re-signs the package using a key (aka re-signing key) that may be a combination e.g., a hash of various keys e.g., as described herein. For example, the re-signing key may be a combination of a key stored/contained/pre-provisioned inside the endpoint enclave and of a key pre-provisioned inside the customer's enclave. If there are plural subcomponents (which may, respectively, have enclaves) that are managed by the endpoint, and the content is intended for certain target subcomponents from among the plural subcomponents, the package may be re-signed with a different key for each target subcomponent.

These keys may be a combination of e.g., a hash of key stored/contained/pre-provisioned inside the endpoint enclave, and/or key pre-provisioned inside the customer's enclave, and/or key pre-provisioned inside the subcomponent enclave.

The key for each subcomponent is typically a one-time signing key generated against a pre-defined (e.g., at provisioning time) certificate aka ENDPOINT_SIGNING_CERTIFICATE. This key may be combined with other (e.g. common) keys.

Thus, the one-time key typically comprises a private key belonging to a private/public key pair associated with a one-time certificate used by the receiver (subcomponent) to verify the signature. Once the subcomponent has verified the signature, the subcomponent can safely use the data which may comprise an update package, list of keys or any other data. Transfer of the signed/encrypted data and one time verification certificate may include leaving signed/encrypted data and one time verification certificate in a pre-defined location e.g. table, which is accessible to the sub component (and the endpoint of course), and, subsequently, the subcomponent may retrieve the signed/encrypted data and one time verification certificate from the known location.

Each re-signed package can, e.g. as described above, be sent onwards to the endpoint's subcomponents (e.g., to a secure input component inside the end-point), for verification and installation of the content on the subcomponent. It is appreciated that the subcomponents need not verify the original package, which may be associated with key management costs e.g., for changing/revoking keys).

According to certain embodiments, content e.g., software code is signed and/or approved by all (or any subset of) the content provider, their customers, each customer's endpoints, and each endpoint's subcomponents.

The subcomponents present in the system may, for example, include all or any subset of the following:
a. A secure input e.g., additional computer or separate hardware processor internal to the endpoint that is in charge of reading keystrokes, encrypting the keystrokes and sending the encrypted keystrokes to the fortress. The data may be update packages.
b. Secure output e.g., an additional computer or separate hardware processor that is internal to the endpoint that is in charge of receiving display encrypted output from the fortress, decrypt it, and present it on the display. Also, in this case the data may be update packages.
c. UEFI, or BIOS, that is in charge of, inter alia, managing the boot keys. Here the data may be new boot keys or update packages.

According to certain embodiments, each time content is passed or sent from one (sending) entity to another (receiving entity) e.g. from the content provider to a customer, or from the customer to an endpoint, the receiving entity verifies (e.g. using public-key cryptography schemes to sign data with a private key, then using the paired public key to verify the signature) that the content came from the alleged sender, and signs the content, typically using the receiving entity's private key, to authorize that the content did indeed come from the alleged sender. It is appreciated that this process may be repeated as the content proceeds through its supply chain, repeatedly being passed or sent from one entity to another. For example, the content may be re-signed, subsequently, by a combination of a customer-provided key (e.g., customer's private key) and an endpoint-provided key (e.g., endpoint's private key).

The combination may include a key composed of plural sub-keys or multiple encryption operations, each employing a separate or different key.

It is appreciated that the system may include all or any subset of the following blocks or entities each of which may be implemented by a suitably configured hardware processor.

Package generator: typically generates packages (e.g., Debian, RPM or Gzipped tar balls) with data in them and typically located in the provider's fortress;

Provider Certificate Authority: typically generates encryption/validation private/public key pairs and certificates (for example elliptic curve based) and typically located in provider secure network;

Provider Transport Package distributor: typically signs and encrypts packages and sends them to the Customer's Transport package receiver and typically located in provider fortress;

Customer Package receiver: typically receives packages (signed and encrypted) from Provider Fortress which is typically located in Customer's fortress; Customer Certificate Authority typically generates encryption/validation keys and certificates and is typically located in Customer fortress at a secure (network-wise) location.

Customer Transport package distributor typically validates Provider signature. It typically adds signature/encryption to the package and sends the encrypted and signed package to the endpoint. It typically executes inside the customer fortress;

Customer “update blob repository”: typically serves out packages to the endpoint.

Endpoint re-signer: typically receives packages from the customer transport package distributor, re-signs the packages, and sends them to the sub-components. It typically executes in a secure enclave on the endpoint;

Sub-components (such as but not limited to secure input, secure output, UEFI) each typically receives re-signed packages from the endpoint re-signer and typically validates signature from endpoint re-signer.

Keys/certificates may include all or any subset of the following:

PROVIDER_SIGNING_{PRIVATE,PUBLIC}_KEY pair which may be generated by Provider Certificate authority. The [PRIVATE] key may be used for signing by Provider Transport package distributor and the [PUBLIC] key may be used for verification by Customer transport distributor.

CUSTOMER_ENCRYPTION_{PRIVATE,PUBLIC}_KEY pair may be generated by Customer Certificate authority. The [PUBLIC] key may be used for encryption by Provider Transport package distributor. The [PRIVATE] key may be used for decryption by Customer transport distributor.

ENDPOINT_ROOT_CERTIFICATE: may be generated by the customer certificate authority. May be used by the secure endpoint enclave to generate a random/single use signing certificate.

ENDPOINT_CERTIFICATE_CHAIN: may be generated by the customer certificate authority. May be provided to the subcomponent and/or to the endpoint as part of the initial provisioning of the endpoint. May be used by the subcomponent to validate the ENDPOINT_SIGNING_CERTIFICATE used to sign the package.

ENDPOINT_SIGNING_CERTIFICATE: may be generated by the secure endpoint enclave. The [PRIVATE] key associated with the certificate may be used by the secure endpoint enclave to re-sign the package. The [PUBLIC] key associated with the certificate may be used by the sub-component to validate the signature of the package after validating the package against the endpoint certificate chain.

According to certain embodiments, two key pairs/certificates (one for encryption, one for validation) are manufactured per endpoint, and/or the content provider and/or per customer (organization or network to which certain endpoints may belong).

It is appreciated that each enclave is provided with a certain infrastructure. Each enclave may be pre-configured e.g., at provisioning time, with logic for performing all or any subset of the operations or functionalities below.

A method of operation for a system including all or any subset of the above blocks or entities, using all or any subset of the above-described keys and certificates, is now described in detail.

All or any subset of the following operations may be provided, suitably ordered e.g. as follows:

Typically, the method may provide endpoints with an enclave residing on each endpoint. Typically, the enclaves are deployed using a process which is trusted by the content provider aka content providing server or central server/s and/or customer. Each enclave may comprise a hardware component that may be provided as part of a larger hardware system e.g. as part of a main board of an endpoint laptop. The trusted process may include deploying software code (or other content) from at least one central server to the enclaves, where the software has been previously signed using a signature that the enclave can verify in order to confirm it is acceptable to execute the code.

Typically, the method may provision endpoints with relevant keys.

Typically, the method may provide content e.g., a blob or payload of data which needs to reach plural subcomponents securely and verifiably. For example, certain code may be written or updated.

Typically, the content provider may sign the code using the content provider's private key (typically is verifiable by the end points), and sends the signed code to its customers; thus, at this stage in the supply chain, all customers typically receive identical data namely the same signed code. Typically, the content provider encrypts the content e.g., blob or payload, with a key openable by endpoints. The content provider may sign with a private key belonging to the content provider which is verifiable by endpoint/s.

Typically, the blob goes from the provider to the customer, and only then to the endpoint. Alternatively, the blob may go directly to the endpoint, without going through the customer.

Typically, the endpoint decrypts the received message and verifies its content/provider. It is appreciated that if the blob goes through the customer, a similar operation may be done there.

Typically, content e.g., blob, is put into the enclave of the endpoint.

Typically, the method may extract the blob e.g. an endpoint uses its private key to decrypt the content e.g. blob. The endpoint has the public keys of the content provider and of the customer, and uses these to verify the signature on the content.

Typically, the endpoint may (e.g., once content has been extracted) sign content using a private key that is a combination of a customer's private key and an endpoint private key.

Typically, the endpoint may encrypt the content signed in operation 80, using encryption that only a given subcomponent knows how to decrypt (e.g., using a subcomponent public key), thereby to yield (re-encrypted and) re-signed content.

Typically, the endpoint sends the (re-encrypted and) re-signed content to subcomponent.

Typically, the subcomponent decrypts content using a subcomponent private key.

Typically, the subcomponent verifies content as decrypted, using a public key which is typically a combination of a customer level key and an endpoint level key. The combination may include a key composed of plural sub-keys or multiple verification operations, each employing a separate or different key.

Typically, once subcomponent processes and has verified the content (e.g., update package or other data or blob), subcomponent runs or otherwise applies or uses the content.

A particular advantage of certain embodiments is preventing a snowball or “lateral movement” effect when an attack occurs at a certain point (e.g., a certain endpoint is compromised by an attacker) and that attacker then gains access to additional endpoints and/or gains the ability to inject incorrect data/keys/update code that can afterwards be leveraged for access and/or exfiltration of data.

For example, part of installing an update in a pre-boot environment may be installation of keys. Attackers can intervene in the “supply chain” and deposit their own signed keys for the UEFI to pick up the next time. These keys may be previously approved keys that have been compromised. Certain embodiments seek to prevent a user from implanting his own keys in a UEFI environment.

According to certain embodiments, content e.g., an update which works at one endpoint, cannot simply be used “as-is” at other endpoints. A package of software that works on and is approved by endpoint x, cannot be used “as-is” at other endpoints, thus limiting the damage to whatever damage the attacker can, from endpoint x only, inflict. Each endpoint typically has its own keys and does its own signing as, more generally, does each entity in the hierarchy e.g. that shown in FIG. 1 by way of example.

For example, an attacker, aka malicious actor, may take over an endpoint or more generally some signing entity e.g. one of the entities in one of the levels in FIG. 1. In the attack, typically, the malicious actor manages to gain the ability to make and sign malicious customizations of content.

Thus the attacker can properly sign content as authentic, even though in fact, the content is attacker-introduced and is malicious. Yet the damage cannot snowball to other endpoints e.g. because software (say) approved by endpoint x (typically using a key unique to endpoint x which differs from the keys that endpoints other than endpoint x respectively use to approve whatever content e.g. software they respectively receive), cannot be used “as-is” at endpoints other than endpoint x. For example, if each end-point x has been sent its own customized copy x of the content, which may include metadata which differs from the metadata of customized copy y which end-point y has been sent, copy x of the content cannot be used as-is by endpoint y, and vice-versa. Since signing is distributed, e.g. as described herein, only sub-components of the attacked end-point or entity can be compromised, whereas entities which are not sub-components of the attacked end-point or entity, cannot be compromised.

In contrast, in conventional systems, all copies of content that entities at a given level receive from a higher level in the hierarchy (e.g. all content that all endpoints receive), all look the same (are identical), thus damage can snowball throughout that level, as well as downward to additional level/s below that level.

It is appreciated that this is particularly advantageous, because the endpoints, being lower in the hierarchy and typically numerous, are more difficult to protect than the higher level of the hierarchy e.g. provider which is easier to protect. Thus, confining damage to specific endpoints and preventing damage from snowballing to non-compromised endpoints yields significant additional security in practice, since, in practice, attacks are by far more common at the endpoint level than they are at the provider (or even customer) level. The advantage conferred is both in limiting damage wreaked by attacks which do occur, and in decreasing motivation of attackers to target systems constructed and operative in accordance with embodiments of the present invention, in the first place.

According to certain embodiments, each endpoint adds metadata, e.g. for personalization of the content that endpoint has received, and generates a package to include the metadata as well as the content received from the next higher level. This may be in the firmware.

Absent the embodiments here, each endpoint may typically get the same content with the same protections that many other endpoints have received (e.g., the same update with the same signature, that of the update provider). Then, an attacker of an individual endpoint (e.g., computer or workstation) may gain access to a verification mechanism (e.g., algorithm) on that computer. That attacker can then sign updates and deploy the re-signed update on other computers, causing damage to snowball. This is particularly the case if all endpoints have the same key (if all sign or encrypt using the same private key, for example).

The enclave is typically configured to perform verification without interference and to perform re-signing e.g., as described herein. Typically, there is nothing inherently secret about the verification mechanism an enclave applies, nor about the public key used to perform the verification.

Another advantage of certain embodiments is that the content provider does not need to store the keys of each endpoint. Instead, this functionality is federated or distributed. Keys/certificates may include all or any subset of those described and listed herein.

Another advantage of certain embodiments is to facilitate the process of trusting a certain computer, and not trusting another computer, because if processes herein are followed, all code on any given computer worthy of trust is known code e.g., is signed and verified. A computer on which unknown code resides, code which has not been signed and verified, is not worthy of trust. The process herein gives a given content provider a way to trust computers by determining whether only known code resides on these computers, and trusting each computer if and only if all code on that computer is known (e.g. is signed and verified as having come from the transport layer “above” the computer which is doing the verifying).

It is appreciated that when data is signed by entity X, this indicates that entity x is approving the correctness/validity of the data. Data thus signed may then be verified by a potential user of this data, according to certain embodiments e.g. as described herein.

It is appreciated that any of the embodiments herein may be advantageously combined or integrated with existing systems such as KAZUAR BLACK available from Kazuar-tech.com and/or KAZUAR Fortress, a secure backend server and/or KAZUAR End Point and/or KAZUAR LITE Fortress and/or any Secured Computer system described in co-owned PCT/IL2019/050343 published as WO 2019/186546, including any claimed embodiment therein, and/or any method for secure communication among protected containers described in co-owned PCT/IL2019/050351 published as WO 2019/186554, including any claimed embodiment therein, and/or any remote Secured Terminal described in co-owned PCT/IL2019/050332 published as WO 2019/186536, including any claimed embodiment therein, and/or any Secure Communication method or System described in co-owned PCT/IL2019/051238 published as WO 2020/105032, including any claimed embodiment therein; the disclosures of all these publications are hereby incorporated by reference.

It is appreciated that keys and/or certifications are typically pre-provisioned, e.g. at an endpoint/system provisioning time, ahead of time or before run-time, e.g. as described herein with reference to operations 1103, 1104, 1106. This may, according to certain embodiments, be done but once, for the lifetime of the equipment.

It is appreciated that terminology such as “mandatory”, “required”, “need” and “must” refer to implementation choices made within the context of a particular implementation or application described here within for clarity, and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations, as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer usable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform, e.g. in software, any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g., by one or more processors. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

The system may, if desired, be implemented as a network—e.g., web-based system employing software, computers, routers and telecommunications equipment, as appropriate.

Any suitable deployment may be employed to provide functionalities e.g. software functionalities shown and described herein. For example, a server may store certain applications, for download to clients, which are executed at the client side, the server side serving only as a storehouse. Any or all functionalities e.g. software functionalities shown and described herein, may be deployed in a cloud environment. Clients, e.g. mobile communication devices such as smartphones, may be operatively associated with, but external to the cloud.

The scope of the present invention is not limited to structures and functions specifically described herein, and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis e.g. triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may for example comprise changing the state or condition, or may more generally cause any outcome which is technically advantageous given the state or condition or data, and/or may prevent at least one outcome which is disadvantageous given the state or condition or data. Alternatively, or in addition, an alert may be provided to an appropriate human operator or to an appropriate external system.

Features of the present invention, including operations, which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art, and particularly, although not limited to, those described in the Background section or in publications mentioned therein.

Conversely, features of the invention, including operations, which are described for brevity in the context of a single embodiment or in a certain order, may be provided separately or in any suitable sub combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g., as illustrated or described herein.

Devices, apparatus or systems shown coupled in any of the drawings may in fact be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g., iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

Any suitable communication may be employed between separate units herein e.g., wired data communication and/or in short-range radio communication with sensors such as cameras e.g. via, Wi-Fi, Bluetooth or Zigbee.

It is appreciated that implementation via a cellular app as described herein is but an example, and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network, or is tethered directly or indirectly/ultimately to such a node).

Any operation or characteristic described herein may be performed by another actor outside the scope of the patent application and the description is intended to include apparatus, whether hardware, firmware or software, which is configured to perform, enable or facilitate that operation, or to enable, facilitate or provide that characteristic.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry, including any such computer microprocessor/s as well as in firmware, or in hardware or any combination thereof.

It is appreciated that elements illustrated in more than one drawing, and/or elements in the written description may still be combined into a single embodiment, except if otherwise specifically clarified here within. Any of the systems shown and described herein may be used to implement or may be combined with, any of the operations or methods shown and described herein.

It is appreciated that any features, properties, logic, modules, blocks, operations or functionalities described herein which are, for clarity, described in the context of separate embodiments, may also be provided in combination in a single embodiment, except where the specification or general knowledge specifically indicates that certain teachings are mutually contradictory, and cannot be combined. Any of the systems shown and described herein may be used to implement or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art. Each element e.g., operation described herein may have all characteristics and attributes described or illustrated herein, or, according to other embodiments, may have any subset of the characteristics or attributes described herein.

The following terms used hereinabove may be construed either in accordance with any definition thereof appearing in the prior art literature or in accordance with the specification, or to include in their respective scopes, the following:

“Fortress” or “secure network” is intended to include any network which is secure because it employs at least one network device or service which protects the network from attack, such as but not limited to a firewall, IDS, UM, and/or VPN.

“Enclave” is intended to include any hardware-protected area in memory, including any hardware component which executes code securely and may be located on a main board such as a laptop that is less secure e.g., because at least one device that allows a hardware component to execute code securely, has been deployed to protect the hardware component, but, typically, has not been deployed to protect the main board. Typically, each enclave herein is networked to its own subpopulation of endpoint computers, from among a population of endpoint computers to which data e.g., updates, which must be secured, are distributed from time to time. Typically, each endpoint computer in the population is networked to an enclave.

Enclaves are also known as “trusted execution environments” which are described in the relevant Wikipedia entry:

en.wikipedia.org/wiki/Trusted execution environment

Examples of conventional enclaves are described in Overview—SGX 101 (gitbook.io).

ca=Certificate authority

Signed encrypted package: a package which is typically first encrypted then signed.

Blob: intended to include a “pile”/super-package of sub-packages that contain both code and data. Also, see Wikipedia's entry re “binary large object”.

Authenticating or verifying or validating: confirming that a blob that has been received was indeed signed by the appropriate authorities which implies confirmation that the blob's content is what it claims to be.

1. A method for securely distributing content to a population of endpoint computers, wherein the method comprises at least 2 of the following 3 operations:
Operation a. providing a hardware processor configured to send signed content from at least one provider, aka content-providing server, to plural customer special-user workstations each including an enclave, wherein each special-user workstation, hence each enclave, is configured to be networked to its own subpopulation of endpoint computers, wherein each said subpopulation is a subset of the population of endpoint computers;
Operation b. In each individual enclave from among said enclaves, providing a hardware processor configured to authenticate that content received was signed by the at least one content-providing server and, having done so, to generate plural non-identical copies of said content received to run on or otherwise be used by plural endpoint computers belonging to the individual enclave's subpopulation of endpoint computers respectively, to sign said plural non-identical copies thereby to yield plural non-identical signed copies, and to send said plural non-identical signed copies to at least some endpoint computers in the individual enclave's subpopulation of endpoint computers;
Operation c. In at least one enclave within at least one endpoint computer, respectively, belonging to a given special-user workstation's subpopulation, providing a hardware processor configured to authenticate that content received was signed by the given special-user workstation and, having done so, to run or to otherwise use the content received that was signed by the given special-user workstation, on or in said at least one endpoint computer,
and wherein at least one individual entity from among the group of entities includes:
the customers/trusted entities/special-user workstations,
their endpoints, and
their endpoint's subcomponents, if any,
re-signs signed content which has been verified by said individual entity using a key which is a combination of keys pre-provisioned in plural entities from among said group of entities.

2. The method according to claim 1 wherein said content comprises an update of software configured to run on at least some endpoint computers within the population of endpoint computers.

3. The method according to claim 1 wherein the plural non-identical copies include personalization metadata.

4. The method according to claim 1 wherein the plural non-identical copies are identical but for personalization metadata.

5. The method according to claim 3 wherein said personalization metadata comprises a logo unique to or used by at least one individual enclave and not to or not by any enclaves other than said at least one individual enclave.

6. The method according to claim 3 wherein said personalization metadata comprises a user name unique to or used by at least one individual endpoint computer belonging to an individual enclave's subpopulation, and not to or not by any endpoint computer belonging to the individual enclave's subpopulation other than said at least one individual endpoint computer.

7. A system comprising at least one hardware processor configured to carry out at least 2 of the following 3 operations:
Operation a. providing a hardware processor configured to send signed content from at least one provider, aka content-providing server, to plural customer special-user workstations, each including an enclave, wherein each special-user workstation, hence each enclave, is configured to be networked to its own subpopulation of endpoint computers, wherein each said subpopulation is a subset of the population of endpoint computers;
Operation b. In each individual enclave from among said enclaves, providing a hardware processor configured to authenticate that content received was signed by the at least one content-providing server and, having done so, to generate plural non-identical copies of said content received to run on or otherwise be used by plural endpoint computers belonging to the individual enclave's subpopulation of endpoint computers respectively, to sign said plural non-identical copies, thereby to yield plural non-identical signed copies, and to send said plural non-identical signed copies to at least some endpoint computers in the individual enclave's subpopulation of endpoint computers;
Operation c. In at least one enclave within at least one endpoint computer, respectively, belonging to a given special-user workstation's subpopulation, providing a hardware processor configured to authenticate that content received was signed by the given special-user workstation, and, having done so, to run or to otherwise use the content received that was signed by the given special-user workstation, on or in said at least one endpoint computer,
and wherein at least one individual entity from among the group of entities includes:
the customers/trusted entities/special-user workstations,
their endpoints, and
their endpoint's subcomponents, if any,
re-signs signed content which has been verified by said individual entity using a key which is a combination of keys pre-provisioned in plural entities from among said group of entities.

8. The method according to claim 7 wherein at least one endpoint computer's enclave re-signs at least one package of content using a key that is a combination of a key pre-provisioned inside the endpoint computer's enclave and of a key pre-provisioned inside the customer's enclave.

9. The method according to claim 7 wherein plural subcomponents each having enclaves are managed by at least one endpoint, and at least one package/s of content intended for certain target subcomponent/s from among the plural subcomponents, is/are re-signed using a different key for each target sub component.

10. The method according to claim 1 wherein at least one enclave on at least one endpoint computer, having authenticated that content received was signed by the given special-user workstation, uses said content locally.

11. The method according to claim 1 wherein, having authenticated that that content received was signed by the at least one content-providing server, said individual enclave signs said content again (aka re-signs the content), thereby to yield re-signed content.

12. The method according to claim 11 wherein said individual enclave re-signs the content received, thereby to yield said re-signed content, with a locally generated one-time key.

13. The method according to claim 12 and wherein said re-signed content and, optionally, associated one time verification certificate, are stored in a local table whose location is known to at least one of said subcomponents, and, subsequently, on at least one occasion on which at least one of the plural endpoint computers boots, said re-signed content and associated one time verification certificate are retrieved from the local table by at least one of said subcomponents.

14. The method according to claim 12 and wherein said re-signed content, and, optionally, associated one time verification certificate, are sent directly to at least one of said subcomponents.

15. A computer program product, comprising a non-transitory tangible computer readable medium having computer readable program code embodied therein, said computer readable program code adapted to be executed to implement a method comprising at least 2 of the following 3 operations:
Operation a. providing a hardware processor configured to send signed content from at least one provider, aka content-providing server, to plural customer special-user workstations, each including an enclave, wherein each special-user workstation, hence each enclave, is configured to be networked to its own subpopulation of endpoint computers, wherein each said subpopulation is a subset of the population of endpoint computers;
Operation b. In each individual enclave from among said enclaves, providing a hardware processor configured to authenticate that content received was signed by the at least one content-providing server and, having done so, to generate plural non-identical copies of said content received to run on or otherwise be used by plural endpoint computers belonging to the individual enclave's subpopulation of endpoint computers respectively, to sign said plural non-identical copies thereby to yield plural non-identical signed copies, and to send said plural non-identical signed copies to at least some endpoint computers in the individual enclave's subpopulation of endpoint computers;
Operation c. In at least one enclave within at least one endpoint computer, respectively, belonging to a given special-user workstation's subpopulation, providing a hardware processor configured to authenticate that content received was signed by the given special-user workstation, and, having done so, to run or to otherwise use the content received that was signed by the given special-user workstation, on or in said at least one endpoint computer,
and wherein at least one individual entity from among the group of entities includes:
the customers/trusted entities/special-user workstations,
their endpoints, and
their endpoint's subcomponents, if any,
re-signs signed content which has been verified by said individual entity using a key which is a combination of keys pre-provisioned in plural entities from among said group of entities.
